(19) United States
(12) Patent Application Publication
(10) Pub. No.: US 2009/0217524 A1
(43) Pub. Date: Sep. 3, 2009

(54) Method and apparatus for manufacturing a honeycomb article

(76) Inventors: Jeffrey John Domey, Elmira, NY (US); James Raymond Mudd, Lindley, NY (US); Robert Daniel Parker, Beaver Dams, NY (US); John Charles Speeckaert, Painted Post, NY (US)

Correspondence Address: CORNING INCORPORATED, SP-TI-3-1, CORNING, NY, 14831, US

(21) Appl. No.: 12/072,753

(22) Filed: Feb. 28, 2008

(51) Int. Cl. B21D 51/16; B29C 65/14

(52) U.S. Cl. 29/890; 264/630; 392/417

(57) ABSTRACT

A method for manufacturing a honeycomb article with an after-applied skin includes fixing a honeycomb body between a first support member and a second support member of a skinning apparatus, the first support member positioned against a first end of the honeycomb body and the second support member positioned against a second end of the honeycomb body. A skin layer is applied to the honeycomb body by an applicator, where a first edge of the skin layer contacts the first support member and a second edge of the skin layer contacts the second support member. At least one of the first edge and the second edge of the skin layer is heated by a heat source before removing the honeycomb body with the applied skin layer from between the first and second support members.

### BACKGROUND

The present disclosure relates generally to a honeycomb article, a method of manufacturing the honeycomb article, and an apparatus for manufacturing the honeycomb article. More particularly, the disclosure relates to a method and apparatus for manufacturing a honeycomb article having an after-applied skin layer.

The use of honeycomb articles as filters for removing particulates (e.g., soot) from engine exhaust gases, and as substrates for supporting catalytic materials for purifying engine exhaust gases is well known. A particulate filter body may be, for example, a honeycomb article having a matrix of intersecting thin, porous walls that extend across and between its two opposing open end faces and form a large number of adjoining hollow passages, or cells, which also extend between and are open at the end faces. To form a filter, a first subset of cells is closed at one end face, and the remaining cells are closed at the other end face. A contaminated gas is brought under pressure to one face (the “inlet face”) and enters the filter body via the cells that are open at the inlet face (the “inlet cells”). Because the inlet cells are sealed at the remaining end face (the “outlet face”) of the body, the contaminated gas is forced through the thin, porous walls into adjoining cells that are sealed at the inlet face and open at the opposing outlet face of the filter body (the “outlet cells”). The solid particulate contaminants in the exhaust gas (such as soot), which are too large to pass through the porous openings in the walls, are left behind, and cleaned exhaust gas exits the outlet face of the filter body through the outlet cells. A substrate for supporting catalytic materials may similarly be a honeycomb article having a matrix of intersecting walls that extend across and between its two opposing open end faces and form a large number of adjoining hollow passages, or cells, which also extend between and are open at the end faces. The walls are coated with a catalytic material selected to reduce the amount of carbon monoxide (CO), nitrogen oxides (NOx), and/or unburned hydrocarbons (HC) in the exhaust gas as the exhaust gas passes through the cells.

Such honeycomb articles are typically formed by an extrusion process where a ceramic material is extruded in a green (uncured) form before the green form is fired to form the final ceramic material of the honeycomb structural article. Generally, as a function of the extrusion process, a solid external surface, or skin, is provided along the length of the extruded form. The extruded green forms can be any size or shape. However, the green forms have relatively low mechanical strength. When made sufficiently large, the extruded green forms may suffer damage or defects at the outer peripheral portion of the form due to, for example, the weight of the article itself causing cells in the outer peripheral portion of the form to collapse or deform, or causing cracks in the skin.

In view of the above, the outer peripheral portion (e.g., the skin and one or more cell layers) of the honeycomb article may be removed, typically after firing of the green form, so as to remove the deformed cells and to provide the honeycomb article with a desired size and shape. A new layer of material may then be applied using techniques known in the art to provide a solid external surface, or skin, along the length of the article. However, the process of forming of the after-applied skin may leave undesired artifacts on the surface of the skin that require further processing steps to remove. It would be advantageous to reduce the formation of undesirable artifacts on the after-applied skin and thereby reduce the processing steps needed to produce a finished honeycomb article.

### SUMMARY

In one aspect, the invention provides a method of manufacturing a honeycomb article. In one implementation, the method comprises the steps of fixing a honeycomb body between a first support member and a second support member, the first support member positioned against a first end of the honeycomb body and the second support member positioned against a second end of the honeycomb body; applying a skin layer to the honeycomb body, wherein a first edge of the skin layer contacts the first support member and a second edge of the skin layer contacts the second support member; heating at least one of the first edge and the second edge of the skin layer; and thereafter removing the honeycomb body with the applied skin layer from between the first and second support members.

In another aspect, the present invention provides an apparatus for manufacturing a honeycomb article. In one implementation, the apparatus comprises a first support member and an opposed second support member, the first and second support members configured to hold a honeycomb body therebetween; an applicator configured to apply a skin layer to the honeycomb body, wherein a first edge of the skin layer contacts the first support member and a second edge of the skin layer contacts the second support member; and a heat source configured to heat at least one of the first edge and the second edge of the skin layer.

Additional features will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments according to the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments according to the invention and together with the description serve to explain the principles and operations of the invention.

### BRIEF DESCRIPTION OF THE DRAWINGS

FIG. 1 is a perspective illustration of a honeycomb article fabricated using conventional methods.

FIG. 2 is a perspective illustration of a honeycomb body after the honeycomb article of FIG. 1 has been shaped and the outer skin removed.

FIG. 3 is a perspective illustration of a honeycomb body with an after-applied skin.

FIG. 4 is a schematic illustration of an apparatus for manufacturing a honeycomb article with an after-applied skin according to the invention.

FIG. 5 is an illustration of pull residue on an after-applied skin of a honeycomb article.

FIG. 6 is a flowchart illustrating a method of manufacturing a honeycomb article according to the invention.

FIG. 7 is an illustration of one embodiment of a support member for use with the apparatus of FIG. 6 to reduce pull residue on an after-applied skin.

FIG. 8 is an illustration of another embodiment of a support member for use with the apparatus of FIG. 6 to reduce pull residue on an after-applied skin.

FIG. 9 is an illustration of yet another embodiment of a support member for use with the apparatus of FIG. 6 to reduce pull residue on an after-applied skin.

### DETAILED DESCRIPTION

Reference will now be made in detail to embodiments according to the invention, examples of which are illustrated in the accompanying drawings. Whenever possible, the same reference numerals are used throughout the drawings to refer to the same or like parts.

Honeycomb articles used for solid particulate filtering, catalytic substrates, and other applications may be formed from a variety of porous materials including ceramics, glass-ceramics, glasses, metals, cements, resins or organic polymers, papers, or textile fabrics (with or without fillers, etc.), and various combinations thereof. Honeycomb articles having uniformly thin, porous and interconnected walls for solid particulate filtering applications are preferably fabricated from plastically formable and sinterable substances that yield a porous, sintered material after being fired to affect their sintering, such as metallic powders, ceramics, glass-ceramics, cements, and other ceramic-bases mixtures. According to certain embodiments, honeycomb articles may be formed from a porous ceramic material, such as cordierite, silicon carbide, or aluminum titanate. Cordierite is a synthetic ceramic composition (2MgO-2Al₂O₃-5SiO₂) having a very low thermal expansion coefficient, which makes the material resistant to extreme thermal cycling. Cordierite also exhibits high temperature resistance (˜1200° C.) and good mechanical strength.

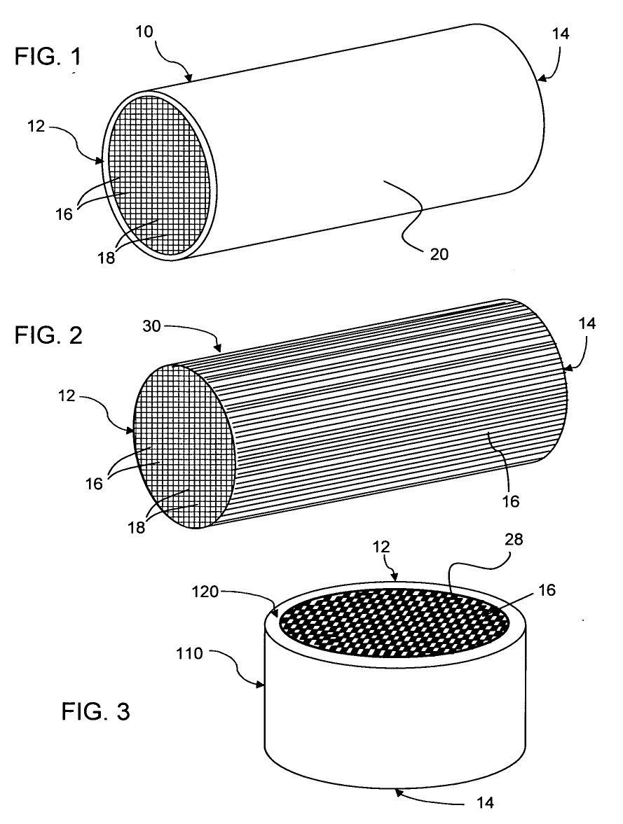

One embodiment of an extruded honeycomb article is shown in FIG. 1, and is designated generally throughout by the reference numeral 10. Honeycomb article 10 has a first end face 12, a second end face 14, and a plurality of hollow, open-ended channels or cells 16 that extend in a generally parallel fashion through honeycomb article 10. Cells 16 are open at end faces 12, 14 of honeycomb article 10, and are formed by a matrix of intersecting walls 18 that extend between end faces 12, 14. Walls 18 have porosity suitable for the intended application of the honeycomb article (e.g., a filter or substrate), and may have either a uniform thickness or a non-uniform thickness, depending upon the intended application. The thickness and spacing of walls 18 are selected to provide a density of cells 16 as is desired for the intended application. In some applications, cell 16 density is in the range of 100-900 cells per square inch, although cell densities lower and higher than that range may also be used. An outer wall or skin 20 extends between end faces 12, 14, bounding cells 16 and walls 18. As used in this disclosure, the term “honeycomb article” is intended to include articles having a generally honeycomb structure and is not limited to articles with cells 16 having a generally square cross-sectional shape. For example, hexagonal, octagonal, triangular, square, rectangular, circular, oval, or any other suitable cell shape may be used. It should be noted that the relative dimensions of cells 16, walls 18 and skin 20 are not to scale.

As described above, in some circumstances honeycomb article 10 is contoured or shaped after it is extruded (and before or after drying and firing of the green form) so as to remove deformed cells 16 and/or to provide a desired size and shape to the contoured article. Contouring or shaping of honeycomb article 10 can be accomplished by any means known in the art, including cutting or grinding away the exterior surface or skin 20 of honeycomb article 10 until the desired shape and size is reached. The final peripheral shape of the may be any possible shape, for example, round, oval, and the like.

FIG. 2 illustrates an embodiment of a honeycomb body 30 resulting from contouring or shaping honeycomb article 10. As used herein, the term “honeycomb body” generally refers to a honeycomb article 10 to which an after-applied skin 120 (described below) is applied. The honeycomb body 30 retains a multiplicity of cells 16 defined by walls 18. However, all or a portion of the outer wall or skin 20 of honeycomb article 10, as shown in FIG. 1, may be removed during a shaping or contouring operation such that cells 16 at the periphery of the shaped honeycomb body 30 are open along the length of the body 30. It should be noted that, although embodiments according to the invention are described herein with reference the application of an after-applied skin 120 to a honeycomb body 30 (from which all or a portion of the original skin 20 has been removed), the teachings of this disclosure are equally applicable to the application of an after-applied skin 120 over an existing skin 20, such as may be required to bring a honeycomb article 10 to a desired size. Accordingly, use of the term “honeycomb body” should be understood to include bodies from which all, a portion, or none of the originally extruded skin 20 has been removed.

Referring now to FIG. 3, after honeycomb article 10 is shaped (and optionally dried and fired), a new external skin (i.e., an after-applied skin) 120 is applied to honeycomb body 30 to form a honeycomb article 110. The after-applied skin 120, as shown in FIG. 3, can be of any material known in the art. By way of example, the honeycomb body 30 can be comprised of cordierite, aluminum titanate, SiC, or other ceramic materials, or combinations thereof. After-applied skin 120 can comprise material that is compatible with the material of the honeycomb body 30. For example, although not required, after-applied skin 120 can comprise material that is substantially identical to the material of the honeycomb body 30. In one embodiment, after-applied skin 120 is a material that is primarily cordierite, with organic and/or inorganic binder components. In one embodiment, the after-applied skin 120 is applied after honeycomb body 30 has been fired and shaped to a desired shape and size.

In FIG. 3, selected ones of cells 16 of honeycomb article 110 have been blocked to form a filter body. The filter body may be formed by plugging, covering or otherwise blocking the open ends of a subset of cells 16 at one end face 12 of the structure, and further blocking all or a portion of the remaining cells 16 at the opposing end face 14 of the structure. In the exemplary embodiment shown in FIG. 3, alternate cells 16 have been blocked with plugs 28 at end face 12 in an exemplary checkerboard pattern. In one embodiment, the plugging pattern on end face 14 (hidden in FIG. 3) is the reverse of that depicted on end face 12. Alternate plugging patterns may be implemented in other embodiments. Selected cells 16 are plugged with a suitable plugging material, such as a sealant or cement mass, which extends from near end faces 12, 14 a short distance into cell 16. Plugs 28 may be formed by any means known in the art. After forming, the sealant or cement forming plugs 28 is cured by any method suitable for the particular material selected so as to form a seal that will substantially block the flow of the gas being filtered. The result is a pattern of plugs arranged on inlet end 12 and outlet end 14 so that contaminate laden gas (such as engine exhaust gas) flows into the filter body, into the filter cells that are not plugged at inlet face 12, through the porous walls 18 of cells 16, and out of the filter body through cells 16 which are not plugged at outlet face 14.

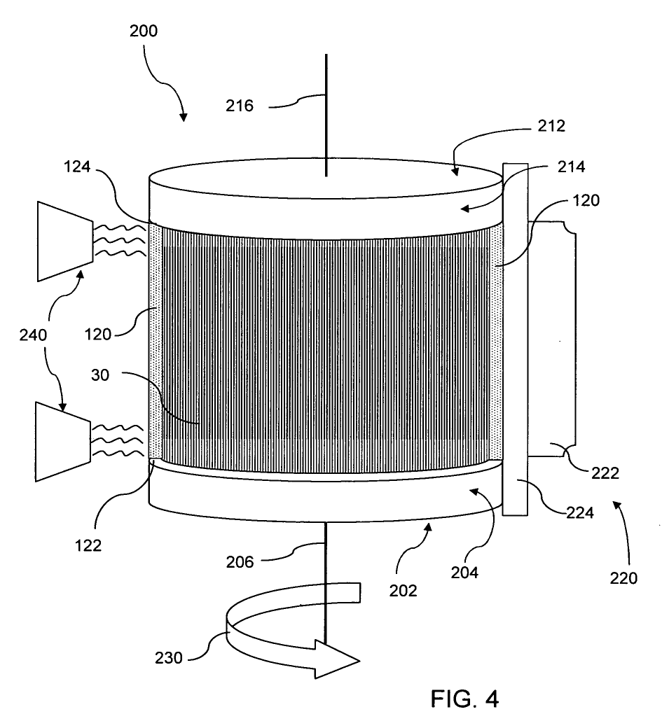

FIG. 4 schematically represents an apparatus 200 for manufacturing honeycomb article 110 according to the present invention, and specifically for applying after-applied skin 120 to honeycomb body 30. The apparatus 200 may be used to apply skin 120 to a wide variety of honeycomb bodies 30, particularly honeycomb bodies 30 comprised of ceramic or ceramic-forming material(s). The honeycomb bodies 30 can be formed into a flow through substrate (e.g., catalyst support) or filter, such as a particulate filter (e.g., comprising a plugged honeycomb body which may include alternately plugged channels).

Apparatus 200 includes a first support member 202 having a peripheral edge 204 and configured to rotate about a first longitudinal axis 206, and a second support member 212 having a peripheral edge 214 and configured to rotate about a second longitudinal axis 216. In the illustrated embodiment, first longitudinal axis 206 and second longitudinal axis 216 are coaxial, although the first and second longitudinal axis 206, 216 may be differently aligned in some applications, as is known in the art. As illustrated, first and second support members 202, 212 comprise plate-like structures, although other structural arrangements may also be used, such as hub and spoke arrangements, lattice structures, and the like. In addition, although support members 202, 212 are illustrated as having circular shapes, other shapes may be used in different embodiments. For instance, the peripheral shape of support members 202, 212 can comprise an oval shape, elliptical shape or other shape that may depend on the shape of a honeycomb body 30 being coated by apparatus 200.

In use, a honeycomb body 30 is fixed between first and second support members 202, 212. The fixation can be provided by compressing honeycomb body 30 between support members 202, 212. Once compressed, the position of honeycomb body 30 is maintained by friction between the upper surface of the honeycomb body 30 and the lower surface of the second support member 212 and friction between the lower surface of the honeycomb body 30 and the upper surface of the first support member 202. Once fixed, the outer peripheral surface of honeycomb body 30 is recessed with respect to the peripheral edges 204, 214 of first and second support members 202, 212, respectively.

Apparatus 200 further includes an applicator 220 configured to apply skin layer 120 to the outer peripheral surface of honeycomb body 30. Applicator 220 can comprise a wide variety of configurations to apply the material forming skin layer 120 in different ways, as are known in the art. For example, applicator 220 can comprise a nozzle 222 or other material dispensing device, and a knife 224. The knife can be configured to simultaneously engage the peripheral edge 204, 214 of support members 202, 212, respectively, when applying the material of skin 120 to the outer peripheral surface of honeycomb body 30. As shown, first support member 202, second support member 212, and honeycomb body 30 fixed therebetween are rotated together in the direction of arrow 230 with respect to the applicator 220. In another embodiment, applicator 220 can be designed to rotate while support members 202, 212 and honeycomb body 30 remain stationary.

As will be understood by those of skill in the art, wet ceramic material is deformable. The term “wet” for the purposes of this disclosure, means a material that has not been fired, dried, sintered, calcined or otherwise exposed to a treatment which causes the material to harden. Thus, as applicator 220 dispenses wet material to form skin 120 and knife simultaneously engages the peripheral edges 204, 214 of support members 202, 212, respectively, the wet material is deformed and spread over honeycomb body 30 so as to be maintained in the space between knife, honeycomb body 30, first support member 202 and second support member 212. A skin 120 of substantially uniform thickness and having an outer peripheral shape matching that of peripheral edges 204, 214 is thus formed.

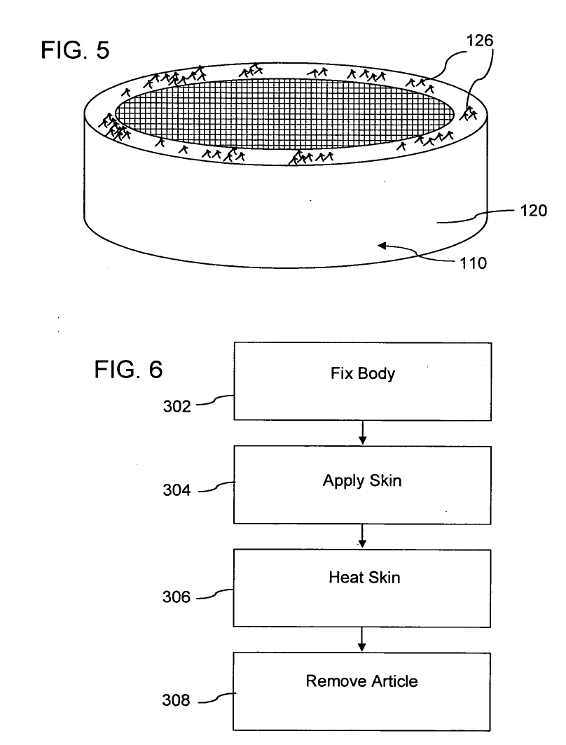

After skin 120 is formed over honeycomb body 30, the honeycomb article 110 must be removed from apparatus 200, and from support members 202, 212, in particular. However, removing the honeycomb article 110 from support members 202, 212 may leave undesired artifacts. In particular, the wet material of skin 120 may be tacky and stick to support members 202, 212 such that when support members 202, 212 are pulled away, some of the wet material of after-applied skin 120 may deform and pull away from the skin 120, leaving behind pull residue on the edges 122, 124 of skin 120 that are in contact with first and second support members 202, 212, respectively. FIG. 5 illustrates pull residue 126 on an edge of skin 120. For the purposes of this disclosure, the term “pull residue” means deformation of skin 120 caused by the removal of one or both of support members 202, 212 from skin 120. In most instances, this pull residue is removed by further processing steps, including cutting, smoothing, grinding or polishing, or any other technique or combination of techniques well known in the art. However, it would be desirable if the need for such additional processing steps (and their accompanying costs) was reduced or eliminated.

Accordingly, as illustrated in FIG. 4, apparatus 200 additionally includes at least one heat source 240. Heat source 240 is configured to heat and thereby dry at least one of first edge 122 and second edge 124 of skin layer 120 (shown in section in FIG. 4) at the interface with support members 202, 204 after wet material forming skin layer 120 has been applied to honeycomb body 30 by applicator 220, and before the honeycomb article 110 is removed from support members 202, 212. Heating edges 122, 124 reduces the adhesion of the wet material to support members 202, 212 by drying, or partially drying, the wet material, such that pull residue on edges 122, 124 of skin 120 is reduced or eliminated when honeycomb article 110 is removed from support members 202, 212. More specifically, drying or partially drying the wet material by heating at one or both of edges 122, 124 results in a high cohesive strength in the material and a high adhesive force between the dried edges 122, 124 and the underlying matrix of honeycomb body 30, thereby overcoming the adhesive force between skin 120 and support members 202, 212 and providing smooth edges 122, 124 on skin 120.

Heat source 240 can comprise a wide variety of heat sources, as are known in the art. In one embodiment, heat source 240 comprises a directed flow of heated air, wherein the air is heated by any suitable means. In one embodiment, air heated to a temperature in the range of about 750° F. to about 1150° F. and having a flow rate in the range of about 250 SLPM (standard liters per minute) to about 400 SLPM is directed toward one or both edges 122, 124 of skin 120. In another embodiment, heat source 240 comprises a radiant heat source, such as an infrared heat source, configured to heat one or both edges 122, 124 of skin 120. In one embodiment, heat source 240 indirectly heats edges 122, 124, such as by heating all or a portion of at least one of first and second support members 202, 212, which in turn heats the adjacent edge 122, 124. In one embodiment, heat source 240 is activated after the application of skin 120 is completed. In another embodiment, heat source 240 is activated before the application of skin 120 is completed.

In one embodiment, heat source 240 is configured to heat edges 122, 124 of skin 120 over as wide of arc of skin 120 as is practical for the particular configuration of apparatus 200. A wider application of heat to edges 122, 124 generally allows faster drying of edges 122, 124, and also reduces thermal gradients within skin 120, which reduces the possibility of cracking or blistering skin 120 during heating. In one embodiment, heat source 240 is configured to heat the entire circumference of the honeycomb article 110 at the same time (i.e., over a 360° arc of skin layer 120). In one embodiment, heat source 240 is configured to heat an arc subtending less than 360° of skin layer 120. In one embodiment, heat source is configured to heat skin layer 120 at more than one location about the circumference of skin 120. In one embodiment, heat source 240 is configured to direct heat toward an arc subtending a total of at least about 10° of skin layer 120.

As described above, in one embodiment, first support member 202, second support member 212, and honeycomb body 30 fixed therebetween are rotatable together in the direction of arrow 230. Accordingly, in embodiments where heat source 240 heats an arc subtending less than 360° of skin layer 120, support members 202, 212 and honeycomb article 110 are rotated with respect to heat source 240, such that the entire circumference of skin 120 is exposed to heat source 240. In another embodiment, heat source 240 can be designed to rotate while support members 202, 212 and honeycomb article 110 remain stationary.

A method of manufacturing a honeycomb article 110 is described with reference to the flowchart of FIG. 6. At 302. a honeycomb body 30 is fixed between first and second support members 202, 212 such that first support member 202 is positioned against first end 12 of honeycomb body 30 and second support member 212 is positioned against second end 14 of honeycomb body 30. In one embodiment, honeycomb body 30 has been contoured prior to being fixed between first and second support members 202, 204. At 304, skin layer 120 is applied to honeycomb body 30, wherein first edge 122 of skin 120 contacts first support member 202, and second edge 124 of skin layer 120 contacts second support member 212. At 306, at least one of first edge 122 and second edge 124 of skin layer 120 is heated to dry or partially dry the heated edge. In one embodiment, both first and second edges 122, 124 are heated. At 308, honeycomb article 110 (i.e., honeycomb body 30 with skin layer 120 applied thereto) is removed from between the first and second support members 202, 212. Upon removal, the heated edges 122, 124 retain the shape and surface contours of the support members 202, 212. For example, when support members are substantially coplanar with ends 12, 14 of honeycomb body 30, edges 122, 124 of skin 120 will likewise be substantially coplanar with ends 12, 14 of honeycomb body 30. Similarly, if support members 202, 212 are shaped to provide a bevel or chamfer at edges 122, 124, edges 122, 124 will retain the shape and texture of shaped support members 202, 212.

Apparatus 200 in general, and heat source 240 in particular is controlled to prevent cracking or blistering of skin 120 during heating. Accordingly, the parameters for heating and drying of skin 120 (in terms of, for example, temperature of heat source 240, temperature of skin 120, exposure time of skin 120 to heat source 240, and the like) are selected according to the properties of the material forming skin 120. In general, higher temperatures require shorter heating times, but increase the possibility of cracking or blistering skin 120. In one embodiment, the temperature of the heated edge 122, 124 is maintained below about 110° F. In one embodiment, the temperature of the heated edge 122, 124 is maintained in a range from about 85° F. to about 110° F.

In one embodiment, heat source 240 heats one or both of edges 122, 124 until the adhesion of the heated edge of skin 120 to the underlying honeycomb body 30 exceeds the adhesion between the heated edge 122, 124 and the support member 202, 212. In one embodiment, heat source 240 heats one or both edges 122, 124 until the heated edge is substantially dry. Drying of the material forming skin 120 may be indicated, for example, by a material color change. In one embodiment, one or both of edges 122, 124 are heated until approximately 0.5 cm to 1.5 cm of skin 120 (as measured from the nearest support member 202, 212) is dried or adhered to the underlying honeycomb body 30.

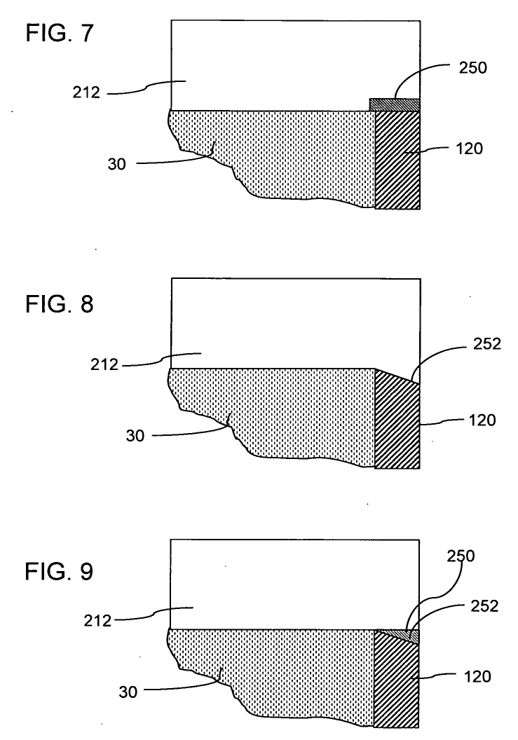

In one embodiment, the use of one or more heat sources 240 may be combined with other devices and methods for reducing pull residue. For example, FIG. 7 illustrates one embodiment of a support member 212 having a nonstick or release layer 250 to reduce pull residue. A nonstick layer 250 may be formed from silicone, polytetrafluoroethylene (PTFE or Teflon®), ultra high molecular weight polyethylene (UHMW), or other known materials suitable for the purpose. A release layer 250 may include a sprayed on or introduced layer of release material such as silicon, starch, or oil. Use of release or nonstick layer 250 decreases the amount of heating and drying of edges 122, 124 required to reduce pull residue.

In one embodiment, as illustrated in FIGS. 8 and 9, one or more of support members 202, 212, and/or nonstick or release layer 250, may be shaped to provide a bevel or chamfer 252 to edges 122, 124 of skin 120. Chamfered edges 122, 124 provide protection from chipping and flaking damage at the edges 122, 124. As noted above, the heated edges 122, 124 substantially retain the shape and surface contours of the support members 202, 212 when removed therefrom, without unwanted pull residue. Accordingly, support members 202, 212 and/or nonstick or release layer 250 may be shaped such that edges 122, 124 of skin 120 will be chamfered in a desired profile when removed from support members 202, 212.

Where honeycomb body 30 has been fired prior to the application of after-applied skin 120, and it is not desirable to expose the fired sintered honeycomb body 30 to another high-temperature firing, it may be desirable to expose after-applied skin 120 to a drying step by exposing the honeycomb body 30 with after-applied skin 120 to temperatures that are not as severe as those used for a firing/sintering step, for example, temperatures below 300° C.

The foregoing description of the specific embodiments reveals the general nature of the invention that others can, by applying knowledge within the skill of the art, readily modify and/or adapt for various applications such specific embodiments, without undue experimentation and without departing from the general concept of the present invention. Such adaptations and modifications, therefore, are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

### EXAMPLES

The invention will be further clarified by the following examples, in which honeycomb bodies (200 cells/in²; 31 cells/cm²) each having a diameter of approximately 12 inches (30 cm) and a length of 12 inches (30 cm) were fixed between support members and prepared with a skin layer formed of a cordierite-based material having a thickness of approximately 1 mm. A manifold was configured to direct heated air toward one edge of the skin at its interface with a support member, with the manifold covering approximately 10 cm of the circumference of the skin layer. The skinned articles were rotated past the manifold at a rotational speed of approximately 10 rpm.

Without any heating, removal of the support member resulted in visible pull residue on the edge of the skin. With heating, each of the following combinations of air temperature, air flow rate (in standard liters per minute) and drying time resulted in no visible pull residue when removing the support member from the honeycomb article.

| | | | Drying time |
|---|---|---|---|
| Sample No. | Air Temp (° F.) | Air Flow Rate (SLPM) | (seconds) |
| 1 | 935 | 300 | 15 |
| 2 | 935 | 300 | 10 |
| 3 | 1100 | 250 | 15 |
| 4 | 1100 | 300 | 30 |
| 5 | 1100 | 300 | 8 |
| 6 | 970 | 300 | 8 |
| 7 | 970 | 300 | 5 |

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of manufacturing a honeycomb article including a first end and a second end, the method comprising the steps of:
fixing a honeycomb body between a first support member and a second support member, the first support member positioned against the first end of the honeycomb body and the second support member positioned against the second end of the honeycomb body;
applying a skin layer to the honeycomb body, wherein a first edge of the skin layer contacts the first support member and a second edge of the skin layer contacts the second support member;
heating at least one of the first edge and the second edge of the skin layer; and
thereafter removing the honeycomb body with the applied skin layer from between the first and second support members.

2. The method of claim 1, wherein heating at least one of the first edge and the second edge of the skin layer comprises heating both the first edge and the second edge of the skin layer.

3. The method of claim 1, wherein heating at least one of the first edge and the second edge of the skin layer comprises heating until the at least one heated edge of the skin layer adheres to the honeycomb body.

4. The method of claim 1, wherein heating at least one of the first edge and the second edge of the skin layer comprises heating until the at least one heated edge is substantially dry.

5. The method of claim 1, wherein heating at least one of the first edge and the second edge of the skin layer comprises maintaining the temperature of the at least one heated edge below about 110° F.

6. The method of claim 1, wherein heating at least one of the first edge and the second edge of the skin layer comprises maintaining the temperature of the at least one heated edge in a range from about 85° F. to about 110° F.

7. The method of claim 1, wherein heating at least one of the first edge and the second edge of the skin layer comprises directing hot air toward at least one of the first and second edges of the skin layer.

8. The method of claim 7, wherein directing hot air toward at least one of the first and second edges of the skin layer comprises directing air having a temperature in the range about 750° F. to about 1150° F.

9. The method of claim 7, wherein directing hot air toward at least one of the first and second edges of the skin layer comprises directing air at a flow rate in the range of about 250 SLPM to about 400 SLPM.

10. The method of claim 1, wherein heating at least one of the first edge and the second edge of the skin layer comprises radiantly heating at least one of the first and second edges of the skin layer.

11. The method of claim 1, wherein heating at least one of the first edge and the second edge of the skin layer comprises heating at least a portion of the support member adjacent at least one of the first and second edges of the skin layer.

12. The method of claim 1, wherein the first and second support members are rotated.

13. The method of claim 12, wherein heating at least one of the first edge and the second edge of the skin layer comprises heating while the honeycomb body and applied skin layer are rotated past a heat source.

14. The method of claim 13, wherein the heat source directs heat toward an arc subtending a total of at least about 10° of the skin layer.

15. The method of claim 1, further comprising contouring the honeycomb body before applying the skin layer.

16. An apparatus for manufacturing a honeycomb article, the apparatus comprising:
a first support member and an opposed second support member, the first and second support members configured to hold a honeycomb body therebetween;
an applicator configured to apply a skin layer to the honeycomb body, wherein a first edge of the skin layer contacts the first support member and a second edge of the skin layer contacts the second support member; and
a heat source configured to heat at least one of the first edge and the second edge of the skin layer.

17. The apparatus of claim 16, wherein the heat source comprises a radiant heat source directed toward the at least one of the first and second edges of the skin layer.

18. The apparatus of claim 16, wherein the heat source comprises a flow of heated air directed toward the at least one of the first and second edges of the skin layer.

19. The apparatus of claim 16, wherein the heat source is configured to direct heat toward an arc subtending at least about 10° of the skin layer.

20. The apparatus of claim 16, wherein the heat source indirectly heats at least one of the first edge and the second edge of the skin layer by heating at least one of the first and second support members.
